(19) United States
(12) Patent Application Publication
(10) Pub. No.: US 2025/0085996 A1
(43) Pub. Date: Mar. 13, 2025

(54) GUEST ADMIN PROTECTION FOR CONFIDENTIAL VIRTUAL MACHINES

(71) Applicant: Microsoft Technology Licensing, LLC, Redmond, WA (US)

(72) Inventors: Saket SUMAN, Bellevue, WA (US); Gangadhara Swamy SHIVAGANGA NAGARAJU, Kirkland, WA (US); Simran PARKHE, Seattle, WA (US); Pushkar V. CHITNIS, Bothell, WA (US); Vikas BHATIA, Kirkland, WA (US); Alec Stephen FERNANDEZ, Durham, NC (US)

(21) Appl. No.: 18/465,148

(22) Filed: Sep. 11, 2023

(51) Int. Cl. G06F 9/455

(52) U.S. Cl. CPC G06F 9/45558; G06F 2009/45587

(57) ABSTRACT

Example solutions for performing attestation for a confidential virtual machine (CVM) provision a confidential virtual machine within a virtualization platform. The virtualization platform includes confidential computing hardware configured to support encryption services to data while that data is in use on the CVM. A third party with administrative rights is provided to the CVM. The administrative rights allow the third party to modify a configuration of the CVM. After the administrative rights of the third party are removed from the CVM, a measurement is received from the CVM. The measurement is added to a build attestation report for the CVM. The attestation report is transmitted to a primary administrative party of the CVM. Using the confidential computing hardware, the CVM enters operational service with confidential data upon receiving certification user input from the primary administrative party who has reviewed the attestation report.

### BACKGROUND

Cloud computing involves sending data to a remote server for processing, which exposes the data to potential security risks. In confidential computing, a set of technologies and practices are implemented in a computing environment to protect sensitive data while at rest (e.g., when stored in persistent storage), while in transit (e.g., when being transmitted across networks), and also while in use (e.g., when in transient memory and being used during processing). While conventional encryption techniques can be used to protect data when at rest or when in transit, the protected data needs to be decrypted before use. Confidential computing uses hardware-based solutions to protect the data while in use.

### SUMMARY

The disclosed examples are described in detail below with reference to the accompanying drawing figures listed below. The following summary is provided to illustrate some examples disclosed herein. The following is not meant, however, to limit all examples to any particular configuration or sequence of operations.

Example solutions for performing attestation for a confidential virtual machine (CVM) include: provisioning a confidential virtual machine within a virtualization platform, the virtualization platform including confidential computing hardware configured to support encryption services to data while that data is in use on the CVM; providing a third party with administrative rights to the CVM, the administrative rights allowing the third party to modify a configuration of the CVM; after the administrative rights of the third party are removed from the CVM, receiving one or more measurements from the CVM; adding the one or more measurements to a build attestation report for the CVM; transmitting the attestation report to a primary administrative party of the CVM; and using the confidential computing hardware, causing the CVM to enter operational service with confidential data upon receiving certification user input from the primary administrative party after review of the attestation report.

### BRIEF DESCRIPTION OF THE DRAWINGS

The disclosed examples are described in detail below with reference to the accompanying drawing figures listed below:

FIG. 1 illustrates an example architecture that advantageously uses confidential computing to protect data while in use;

FIG. 2 is a state diagram illustrating an example build process for a confidential virtual machine (CVM) that advantageously uses attestation features to capture measurements during build of the CVM;

FIG. 3 is a flowchart illustrating exemplary operations that may be performed for providing software-based attestation during a build process of a CVM;

FIG. 4 is another flowchart illustrating exemplary operations that may be performed for providing software-based attestation during a build process of a CVM; and

FIG. 5 is a block diagram of an example computing device (e.g., a computer storage device) for implementing aspects disclosed herein, and is designated generally as a computing device.

Corresponding reference characters indicate corresponding parts throughout the drawings. Any of the drawings may be combined into a single example or embodiment.

### DETAILED DESCRIPTION

To protect sensitive data while in use, computational computing hardware and techniques can be used to limit access to sensitive data, such as healthcare data, personally identifiable information, intellectual property, or the like. This specialized hardware can be used to provide trusted execution environments (TEEs) or secure enclaves to preserve data encryption by controlling when the execution environment can decrypt the data. Such solutions typically rely upon providing access to a decryption key for the sensitive data only when certain policy goals are verified.

A computational computing (CC) system provides a confidential virtual machine (CVM) within a virtualization environment that provides enhanced data protection for protected data while in use. In examples, a CVM is provisioned and access is provided to a third party (a “guest administrator”), such as an independent software vendor (ISV), during a build stage of the CVM. This third party installs and configures software that will be executed by the CVM. The third party may also configure the CVM with various hardening and integrity protection techniques, such as applying security patches, and removing aspects of network accessibility and administrative rights to the CVM. Once the build of the CVM has been completed by the third party and all third-party access has been removed from the CVM, a final image of the CVM is provisionally prepared for operational use (e.g., contingent upon review and approval).

To protect against potential security exposures from this third party, the CC system captures measurements of the CVM at various points during the build process of the CVM. At each “build checkpoint,” current measurements of various aspects of the CVM are captured and sent to an attestation service. These measurements may include current access status (e.g., what administrative accounts are present on the CVM), software configuration status (e.g., what software is installed, current software settings), network configuration status (e.g., what methods of network access are currently enabled, current network configuration), and one or more hashes of the persistent storage used by the CVM (e.g., hash of the OS virtual disk). Further, the third party provides a list of changes that were performed since the last checkpoint, indicating what was changed on the CVM. These measurements are compiled into a build attestation report that may be consumed by a data owner (e.g., the party that is entrusted with protecting this sensitive data).

The build attestation report allows the data owner to review the creation process of this image and to have this creation process audited by another provider. Since the attestation service captured measurements at various build checkpoints, these measurements may be used by an auditor to independently recreate the image and compare that image, and its measurements, against the original measurements at each build checkpoint (e.g., implementing the changes identified by the third party up to each checkpoint). The build attestation report and audit process helps ensure the data owner that no malicious software was installed, or other malicious configurations were introduced, during the construction of the final image. As such, the image may be verified and certified for use by the data owner before the data owner allows that final image to be used with their protected data during operation.

Example solutions use attestation techniques to capture measurements during or after a build process of a CVM. These captured measurements facilitate security and operational integrity of, and trust in, the CVM by providing a repeatable process that can be used to verify operations performed while creating the CVM (or an operating system image used by the CVM). The example solutions provide technical advantages in computer processing with improved data security over existing approaches by, for example, tracking administrative operations performed on the CVM during build time and capturing key measurements from the CVM at checkpoints during the build process by, for example, capturing measurements from the CVM after a build process is performed by a third party and transmitting an attestation report that includes those measurements to an administrative party for review prior to allowing the CVM to enter operational service with confidential data. Further, these techniques also further improve data security by, for example, receiving evidence from an attestation agent being executed by the CVM and verifying that evidence against expected values before causing the CVM to enter operational service. Where existing solutions utilize hardware-based solutions to attest to and verify certain hardware-based configurations related to confidential compute hardware used to support the CVM, the solutions described herein also allow for measurements to, additionally or alternatively, be captured from within the CVM (e.g., operating system details, application installation details) and compared to expected measurements seen and verified during the build process.

The various examples are described in detail with reference to the accompanying drawings. Wherever preferable, the same reference number is used throughout the drawings to refer to the same or like part. References made throughout this disclosure relating to specific examples and implementations are provided solely for illustrative purposes but, unless indicated to the contrary, are not meant to limit all examples.

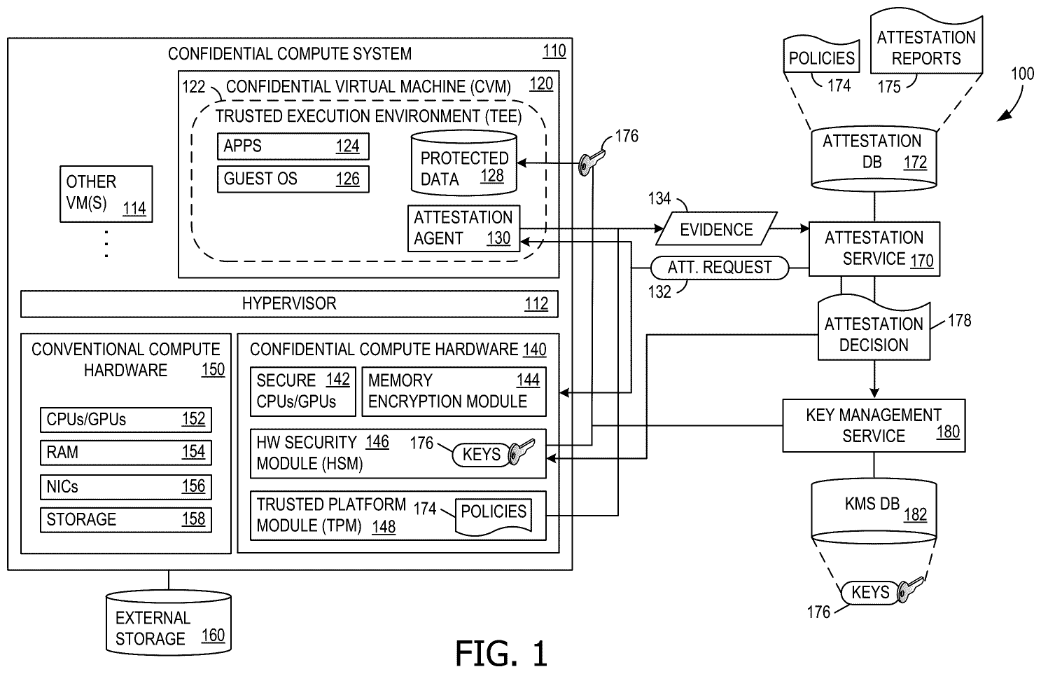

FIG. 1 illustrates an example architecture 100 that advantageously uses confidential computing to protect data 128 while in use. In architecture 100, a confidential compute (CC) system 110 provides a virtualization environment upon which virtual machines may be provisioned and ran, including a confidential virtual machine (CVM) 120 and other VMs 114 (e.g., as supported by a hypervisor 112). The architecture 100 also includes an attestation service 170 that is configured to attest to the character of evidence 134 received from the CC system 110 prior to use of protected data 128 on the CVM 120. More specifically, the attestation service 170 compares the evidence 134 received from the CC system 110 against one or more policies 174 that dictate what conditions are required of the CC system 110 prior to entrusting that CC system 110 to use the protected data 128. The CC system 110 supports several examples that control access to the protected data 128 via access to a decryption key 176 that can be used to decrypt the protected data 128 prior to use (e.g., at run time, during an operational phase of the CVM 120).

In examples, the confidential compute system 110 includes conventional compute hardware 150, such as one or more central processing units (CPUs) and/or graphics processing units (GPUs) 152, transient memory (e.g., random access memory (RAM)) 154, one or more network interface cards (NICs) 156 (e.g., Ethernet network cards, storage area network (SAN) cards, or the like), and local storage 158 (e.g., disk drives, solid state drives (SSDs), or the like). The conventional compute hardware 150 can include any other conventional hardware, not separately shown here, that is sufficient to enable the systems and methods described herein. The CC system 110 may also have access to external storage 160 (e.g., cloud storage, SAN storage, or the like).

Additionally, the example architecture 100 also includes confidential compute hardware 140. Confidential compute hardware 140 includes hardware components that are configured to enable aspects of confidential computing systems and techniques. The confidential compute hardware 140 can include secure CPUs/GPUs 142, memory encryption module(s) 144, and associated hardware and firmware, such as, for example, INTEL® Xeon scalable processors with Software Guard Extensions (SGX), AMD® secure processors with Secure Encrypted Virtualization (SEV and SEV-ES) and Secure Memory Encryption (SME), ARM Cortex-M processors with TrustZone, or the like. Such confidential compute hardware 140 (e.g., secure CPUs/GPUs 142, memory encryption module 144) allows the CC system 110 to, for example, provision and run CVMs 120 or encrypted virtual machines, trusted execution environments (TEEs) 122, or enclaves (not separately shown here), perform memory isolation or memory encryption, or implement hardware-enforced access controls. Confidential compute hardware 140 can include hardware security module(s) (HSM) 146 or trusted platform modules (TPMs) 148, which are specialized hardware devices designed to store cryptographic keys 176 and perform secure cryptographic operations to enhance the security of sensitive operations and perform other operations configured to enhance security of the confidential compute system 110, such as supporting hardware attestation, secure boot, key management, data sealing/unsealing, secure random number generation, secure storage, platform integrity reporting, and the like. While only some examples of confidential compute hardware 140 are given here, it should be understood that any such confidential compute hardware that enables the systems and methods described herein may be included in the architecture 100.

In examples, the CVM 120 provides a trusted execution environment (TEE) 122. The TEE 122 is a secure and isolated environment within the confidential compute system 110 where sensitive computations and operations can be executed securely. In some examples, the TEE 122 implements hardware features that include SGX, SEV, ARM TrustZone, or the like, to provide strong isolation between the environment of the TEE 122 and the rest of the confidential compute system 110 (e.g., via isolated memory space, execution environment, dedicated secure GPUs/GPUs 142 for processing, or the like).

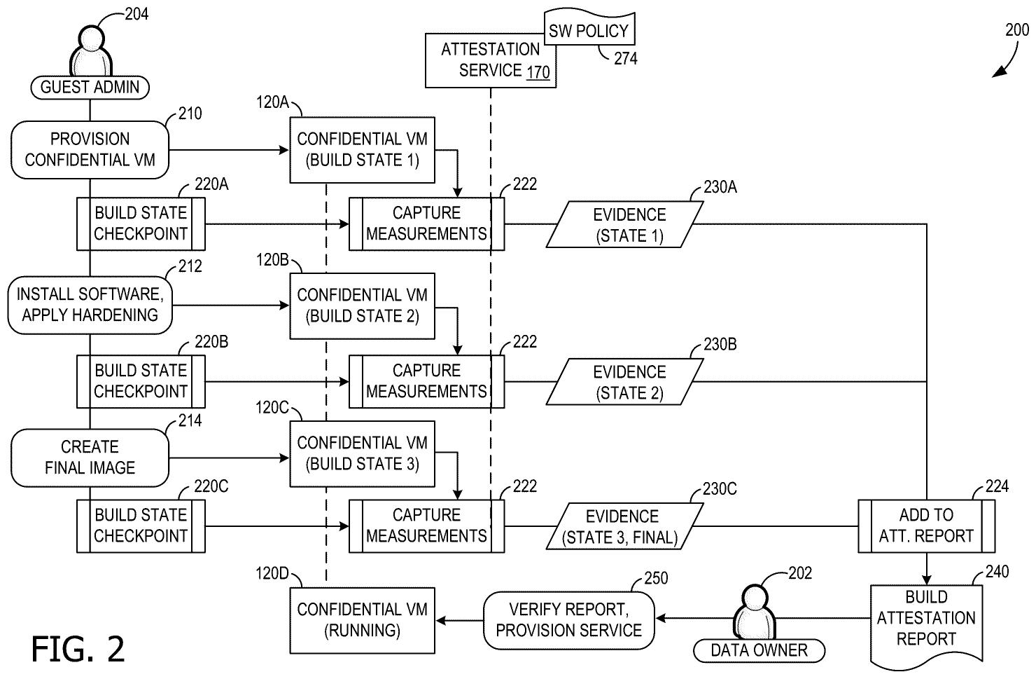

The TEE 122 is configured with a guest OS 126 and one or more user applications (or just “apps”) 124. In these examples, the app(s) 124 represent the primary intended use and utility of this CVM 120 during an operational phase, and the protected data 128 represents the sensitive data that is used in some way by those apps 124. The apps 124 are installed on the CVM 120 during a build phase, before the CVM 120 is trusted with the protected data 128. During the build phase of this CVM 120, administrators configure the CVM 120 to prepare and harden the TEE 122 for future use. Once the CVM 120 is prepared for use, the CVM 120 enters an operational phase in which protected data 128 is transferred to the CVM 120 after a “runtime attestation” operation is completed. Further, in some examples described herein, the CVM 120 also undergoes a “build attestation” operation prior to entering operational service (e.g., prior to the runtime attestation). The build attestation process involves measurements of the CVM 120 at particular points of time (“build checkpoints”), each and all of which may also be attested to prior to entering operational service. This build attestation process is described in further detail below, particularly in regard to FIG. 2.

The runtime attestation operation includes capturing evidence 134 associated with the configuration of the CVM 120 and the components of the confidential compute system 110 to determine whether or not the CVM 120 is allowed to be trusted with the protected data 128. During a configuration stage, a data owner (e.g., the entity controlling access to and use of the protected data 128) establishes a policy 174 (e.g., a security policy or expected state) for use of the protected data 128. More specifically, this policy 174 defines a set of conditions that must be met before the CVM 120 is trusted with the protected data 128. These conditions can include, for example, a verification of the source (e.g., to ensure that the evidence 134 is coming from a legitimate and trusted source), a verification of the integrity of the evidence 134 (e.g., to ensure that the evidence 134 has not been tampered with), a set of known good measurements that represent a secure and trusted system state (e.g., as compared to the actual measurements provided in the evidence 134), and a verification of the validity of attestation keys used to sign the evidence 134, amongst others.

Some of the evidence 134 used to verify the confidential compute system 110 during a runtime attestation operation includes measurement of a boot process (e.g., a series of hashes or measurements that represent the state of the boot process, from firmware to operating system and applications, to ensure that the boot process was not tampered with), information about a memory layout, code and data hashes, or cryptographic signatures (e.g., in technologies that provide secure enclaves and associated technologies), hashes or measurements of critical software components (e.g., bootloaders, system libraries, kernel modules), hashes of files or components along with digital signatures from a trusted authority (e.g., to verify the integrity of code and data), platform configuration details (e.g., information about the hardware configuration of the CC system 110 and confidential compute hardware 140, firmware version, CPU features, and the like), platform identity information (e.g., information the unique identity of the confidential compute system 110 or the CVM 120), chain of trust information (e.g., information about the sequence of measurements, digital signatures, and keys that establish a chain of trust from hardware to software components), Secure World measurements (e.g., in ARM TrustZone, evidence might include measurements of the state of the Secure World, such as the Secure Monitor and secure applications), TPM quotes (e.g., the TPM 148 may generate quotes that include a set of Platform Configuration Registers (PCRs) with hash values of important system components), information on debugging environments (e.g., whether debugging tools or environments are enabled), and hardware attestation (e.g., some hardware components may have built-in attestation mechanisms that generate evidence about their state and configuration). The combination of these types of evidence allows the verifier to assess the state of the confidential compute system 110 and/or the CVM 120 before access to the protected data 128 is granted.

In examples, the architecture 100 includes an attestation service 170 that performs attestation verification on behalf of the data owner. In these examples, where the CC system 110, CVM 120, or TEE 122 may act as the “attester” (e.g., the entity in which trust to execute the apps 124 with the protected data 128 is sought), the attestation service 170 acts as the “verifier” for build attestation operations (e.g., the entity which approves or denies that trust). In some examples, the attestation service 170 also acts as the verifier for runtime attestation operations. In some examples, the attestation service 170 may execute as a cloud-based service offered by a cloud architecture, or an edge server or other centralized server (e.g., where the CVM 120 or the CC system 110 is the edge device). In other examples, the attestation service 170 may execute on one of the other VMs 114 of the CC system 110. In still other examples, the attestation service 170 may execute in a peer-to-peer network. The attestation service 170 may be provided in any architecture that supports the systems and methods described herein.

The attestation service maintains an attestation database (DB) 172. This attestation DB 172 is configured to store policies 174 that are used to evaluate evidence 134 provided during build and/or runtime attestation operations. Further, the attestation DB 172 may also store attestation reports 175. An attestation report 175 is a report that collects data about a particular attestation operation that is performed. This data can include, for example, the evidence 134 provided by attesting entities during the given attestation operation, identity information about the attester(s), data about the attestation decision 178 of that attestation operation (e.g., whether or not trust was given), and information about the policy 174 that was used to generate the attestation decision 178.

During an example attestation operation, the attestation service 170 transmits an attestation request 132 to the CC system 110. This attestation request 132 prompts a response of some evidence 134 from the attesting entity. In runtime attestation operations, this attestation request 132 is sent to some component(s) of the confidential compute hardware 140, and thus the attester is that responding component of CC hardware 140. In build attestation operations, this attestation request 132 is sent to an attestation agent 130 provided by (e.g., installed on) the CVM 120, and thus the attester is the attestation agent 130 of the CVM 120.

The attestation agent 130 is a trusted and hardened software component installed on the CVM 120, typically during a build process of the CVM 120, that acts as an agent to the attestation service 170. The attestation agent 130 is configured and locally privileged to collect certain types of evidence 134 from within the CVM 120. The attestation agent 130 is preconfigured to answer to particular types of requests for particular types of data. In the example, the attestation agent 130 exposes an application programming interface (API) that is used to receive and respond to attestation requests 132 from the attestation service 170, providing evidence 134 that is collected by the attestation agent 130 from within the CVM 120. In some examples, the attestation agent 130 provides user data from the CVM 120 (e.g., what administrative or other privileged user accounts are currently present on the CVM 120), software installation and configuration information of the CVM 120 (e.g., what software components are currently installed on the CVM 120), networking configuration information of the CVM 120 (e.g., what network services are active, what TCP/IP ports are open), and hashes of aspects of the CVM 120 (e.g., hashes of portions of the guest OS 126 or underlying storage). Further, the attestation agent 130 may be configured to authenticate the attestation service 170 prior to responding to any attestation requests 132 and may specifically answer requests 132 from, and provide evidence 134 to, only the attestation service 170 (e.g., after a registration and configuration process that permissions the attestation agent 130 to communicate with the attestation service 170).

During an example build attestation process of the CVM 120, the attestation service 170 creates and transmits one or more attestation requests 132 to the attestation agent 130 of the CVM 120. These attestation requests 132 identify what evidence 134 is desired to be retrieved from the CVM 120. For any given CVM 120, the evidence 134 requested from the CVM 120 is identified by a policy 174 that has been configured for, or otherwise assigned to, that CVM 120. This policy 174 thus defines the data of potential interest to the data owner (or auditors) for verifying trust in the build process of the CVM 120. In other words, the policy 174 identifies what data is requested by the attestation request(s) 132, and thus what data is collected from the CVM 120 and provided (e.g., attested to) by the attestation agent 130 (e.g., as evidence 134). In some examples, the attestation service 170 may perform several “checkpoint” requests during a build process of the CVM 120, thus capturing data about the CVM 120 during the build process that can be used, for example, to verify the integrity of CVM 120 at that stage of the build process or to audit the build process (e.g., by comparing to expected values). Additional details regarding build attestation operations are described in greater detail below with regard to FIG. 2.

Some attestation operations are performed to verify whether or not to allow the CVM 120 to proceed into operational use. For example, during a runtime attestation operation, the attestation service 170 may send attestation requests 132 to the CC hardware 140 (e.g., to verify that particular hardware and configurations are being used to support the CVM 120). These attestation requests 132 to CC hardware 140 (“hardware-based attestation requests,” for aspects of evidence 134 that are collected by components of CC hardware 140) may be defined in the policy 174 for the CVM 120. This “hardware-based evidence” ensures that aspects of the CC hardware 140 supporting the CVM 120 is sufficiently configured and hardened before the CVM 120 is allowed access to the protected data 128. In some examples, the policy 174 may, additionally or alternatively, include attestation requests 132 to the attestation agent 130 (“software-based attestation requests,” for aspects of evidence 134 that are collected within the CVM 120). This “software-based evidence” or “internal evidence” generated from within the CVM 120 (e.g., internal to the CVM 120 and the guest OS 126) helps ensure that internal aspects of the CVM 120 is sufficiently configured and hardened, and has not been tampered with, prior to allowing the CVM 120 to access the protected data 128.

During the example attestation operation, the policy 174 for the CVM 120 or CC system 110 identifies what evidence 134 is collected via the attestation request(s) 132. Each component of evidence 134 (e.g., each measurement) is compared to an associated policy component to determine whether or not that policy component is satisfied (e.g., where the expected value is defined by the policy component and where the actual, current value is provided by the measurement, as provided by either the CC hardware 140 or the attestation agent 130).

After comparing all of the evidence 134 to the policy 174, the attestation service 170 generates an attestation decision 178 (e.g., verifying the CVM 120 to proceed with accessing the protected data 128 or denying the CVM 120 access to the protected data 128). In some examples, the attestation decision 178 may be recorded by the attestation service 170 (e.g., via an attestation report 175), and may include the overall results (e.g., allow or deny) and individual comparison results of each policy component (e.g., pass or fail for each particular comparison, or the like).

Upon a positive verification, the CVM 120 is provided with the protected data 128 (e.g., initially in encrypted form) and a decryption key 176 that allows the CVM 120 to decrypt the protected data 128. In some examples, the architecture 100 uses a key management service (KMS) 180 and a KMS database (DB) 182 to store and manage access and distribution of keys 176. In some examples, keys 176 are managed by the HSM 146. Upon receipt of the attestation decision 178, the key management service 180 transmits a key 176 for the protected data 128 to the CVM 120 (e.g., via an encrypted communication channel with the CVM 120). The key 176 allows the CVM 120 to decrypt the protected data 128, thus allowing the CVM 120 access to the protected data 128 for use during operation.

While the distribution of the encrypted, protected data 128 is not expressly shown or detailed herein, it should be understood that the architecture 100 is presumed to provide any type of distribution method to transfer or otherwise allow access to the protected data 128 (e.g., in its encrypted form) to facilitate eventual use of the protected data 128 (e.g., after proper attestation and verification by the attestation service 170). As such, the protected data 128 is presumed present on the CVM 120 for use after successful attestation and verification.

FIG. 2 is a state diagram illustrating an example build process 200 for the CVM 120 that advantageously uses attestation features to capture measurements during build of the CVM 120. In this example, the CVM 120 is provided and managed by the architecture 100 shown in FIG. 1. During the build process 200, the CVM 120 undergoes changes performed by a guest administrator (“guest admin”) 204. The guest admin 204, in this example, is acting on behalf of a data owner 202 to create and harden the CVM 120 before the CVM 120 is deployed into operation. Further, the attestation service 170 (shown in FIG. 1) captures measurements 222 at several points in time during the build process 200, represented in FIG. 2 as build state checkpoints 220.

In the example shown in FIG. 2, the CVM 120 is shown in four states of its build lifecycle, namely CVM 120A in a “build state 1,” CVM 120B in a “build state 2,” CVM 120C in a “build state 3,” and CVM 120D in a “running” state. During the build process 200, the guest admin 204 transforms the CVM 120 by performing various build operations to the CVM 120.

For example, at operation 210, the guest admin 204 begins the build process 200 for the CVM 120 by provisioning the CVM 120 (e.g., within the CC system 110). This provisioning operation 210 can include creating the TEE 122, associating particular CC hardware 140 with the CVM 120, and installing an operating system image onto the CVM 120 (e.g., the guest OS 126). Further, the provisioning operation 210 also includes installing the attestation agent 130 onto the CVM 120 and configuring the attestation agent 130 to communicate with the attestation service 170. Installation of the attestation agent 130 allows the attestation service 170 to capture measurements 222 from the CVM 120 at the various build state checkpoints 220.

After the provisioning operation 210 is performed, the CVM 120A is in build state 1. At this time, the attestation service 170 captures measurements 222 at a first build state checkpoint 220A (e.g., via an attestation request 132). More specifically, and during each of the build state checkpoints 220A-220C shown in FIG. 2, the attestation service 170 uses a software (SW) policy 274 for the CVM 120 to create one or more attestation requests 132 for the CVM 120. This SW policy 274 identifies what evidence 134 is requested for attestation by the CVM 120 during this build process 200. Capturing measurements 222 thus includes the attestation service 170 creating attestation requests 132 (e.g., based on the SW policy 274) and sending those attestation requests 132 to the CVM 120. At this first build state checkpoint 220A, the CVM 120A responds to those attestation requests 132 with evidence 230A. The evidence 230A-230C may be similar to the evidence 134 shown in FIG. 1, and particularly represents the internal evidence collected from within the CVM 120 by the attestation agent 130 of the CVM 120. At operation 224, the evidence 230A (e.g., the internal evidence) collected at state 1 of the CVM 120A is added to a build attestation report 240. The types of evidence 230 collected at the build state checkpoints 220 is described in greater detail below.

Further, in some examples, a list of changes performed by the guest admin 204 prior to the first build state checkpoint 220A (e.g., during the provisioning operation 210) is logged with the build attestation report 240. This change log can help the data owner 202, or an auditor working on behalf of the data owner 202, to verify the integrity of the CVM 120A at that first build state by, for example, recreating the CVM at some later time (e.g., by performing the same operations identified by the guest admin 204 via the change log), capturing measurements 222 of that recreated CVM, and comparing the measurements to the measurements recorded in the build attestation report 240. If the recreated CVM does not generate measurements that match the build attestation report 240, this can be an indication that some unknown changes occurred during the build process 200, and thus the resulting CVM 120 may not be trustworthy.

At operation 212, the guest admin 204 installs software and hardens the CVM 120. In this example, the software installed on the CVM 120 are the apps 124 that will eventually execute on the CVM 120 during operation, and which may use the protected data 128 (e.g., after a runtime attestation). The secure installation and hardening techniques of operation 212 can include, for example, installing the guest OS 126 and apps 124 from trusted, certified installation images (e.g., digitally signed “golden” images known to be free of malware or otherwise contain approved versions of OS 126, patches, security configurations and settings, approved versions of apps 124, and the like), removing administrative users and privileges, and restricting types of network access available to and from the CVM 120 (e.g., restricting secure shell (SSH) access, console access).

Further, several hardening operations can be performed during the build of the CVM 120 and the TEE 122, based on the TEE technologies used by the confidential compute system 110. These hardening techniques can include, for example: secure boot and initialization can be implemented to ensure that the TEE 122 starts in a trusted state (e.g., verifying the integrity of boot components and establishing a chain of trust from the hardware 140, 150 to the TEE 122): setting up and establishing a strong root of trust (e.g., to ensure the authenticity and integrity of the TEE's components and software stack); review of code and configuration (e.g., a review or audit of the code and configuration settings installed on the TEE 122 to identify and address potential vulnerabilities or misconfigurations); establishing cryptographic key management for the CVM 120 (e.g., supporting key generation, storage, distribution, and revocation features to support keys 176 for the CVM 120); memory isolation and access control (e.g., configuring memory isolation for transient memory used by the TEE 122 to prevent unauthorized access to the memory regions assigned to the TEE 122 and enforce access controls to ensure only authorized code and processes can access the resources of the TEE 122): securing communications vectors for the CVM 120 (e.g., implementing secure communication protocols for interactions between the TEE 122 and other components, ensuring data confidentiality, integrity, and authentication); securing input/output handling (e.g., safeguarding input and output mechanisms to prevent data leaks or manipulations, including input validation, output sanitization, and handling of potentially malicious input); minimization of attack surfaces (e.g., disabling unnecessary services, removing unnecessary code, and disabling bug features that could be exploited): patch and update management (e.g., establishing a process for timely patching and updating of the TEE 122 to address security vulnerabilities and bugs); testing and validation (e.g., conduct thorough security testing, penetration testing, and vulnerability assessment to identify and address weaknesses); firmware and software supply chain security (e.g., ensure that the firmware and software components used in the TEE 122 have not been tampered with during their supply chain and distribution); security monitoring and incident response (e.g., setting up monitoring mechanisms to detect unusual behavior or security incidents within the TEE 122, establish procedures for responding to and mitigating potential security breaches): configuration hardening (e.g., implementing recommended security configuration settings to reduce the attack surface and strengthen the security posture of the TEE 122); and security documentation (e.g., creating comprehensive documentation detailing the security features, configuration, and hardening practices of the TEE 122).

After the software installation and hardening of operation 212, the attestation service 170 again captures measurements 222 at a second build state checkpoint 220B, resulting in the collection of evidence 230B at build state 2 of the CVM 120B. This evidence 230B is likewise added to the build attestation report 240 at operation 224.

At operation 214, the guest admin 204 finalizes the CVM 120C and creates a final image (a “golden image”) for the CVM 120C at a final build state, build state 3. The finalization at operation 214 can include final removal of administrative access of the guest admin 204 to the CVM 120C (e.g., via removal of administrative accounts, or the like), creation of final hash values of portions of the filesystem(s), and memorialization of the final image (e.g., generating a final golden image that can be deployed on future CVMs 120 in the architecture 100, digitally signing the image, and the like).

After the final image is created, the attestation service 170 again captures measurements 222 at a third and final build state checkpoint 220C, thereby capturing evidence 230C at build state 3 of the CVM 120C. This evidence 230C is also added to the build attestation report 240 at operation 224. While the example of FIG. 2 shows three build state checkpoints 220A-220C, it should be understood that any number of one or more build state checkpoints 220 can be performed during the build process. In some examples, only one build state checkpoint 220C is performed at the end of all administrative operations performed by the guest admin 204 (e.g., after all changes to the CVM 120 are completed and the CVM 120 is finalized for operational use).

In examples, the evidence 230 collected at each of the build state checkpoints 220A-220C is defined by the SW policy 274. More specifically, the SW policy 274 identifies one or more aspects of internal evidence to be attested to at each checkpoint 220. In some examples, the internal evidence collected at each checkpoint 220 includes current user account information on the CVM 120, and particularly for administrative accounts currently present on the CVM 120. Administrative accounts can include operating system-level administrative accounts (e.g., ‘root’ under Linux, ‘administrator’ account under Windows, or the like, as well as user-level accounts or other accounts native to the OS that have elevated privileges). Administrative accounts can also include administrative accounts specific to particular software (e.g., to the apps 124 installed on the CVM 120), such as, for example, administrative accounts of a database management system (e.g., used to configure, manage, and maintain databases), administrative accounts of a content management system (CMS) (e.g., used to manage website content, install plugins, and control user access levels), and administrative accounts of virtualization platforms such as the CC system 110 (e.g., used to create and manage VMs, configure virtual networks, and control various other aspects of the virtualization environment) or cloud service providers (e.g., used to control access to cloud resources, manage virtual instances, and set up network configurations). The user account information collected by the SW policy 274 can include a list of user accounts present on the CVM 120 (e.g., by user/account name), as well as account details of each account, such as, for example, account creation date/time, login history, encrypted password, failed login attempts, privilege escalation attempts, file/folder access logs, system configuration changes and security policy changes performed by the account, user modifications made by the account, application management operations performed by the account (e.g., logs of installation/uninstallation and management of apps 124 and services of the guest OS 126), and remote access logs (e.g., if the account was remotely accessed, details about the remote session such as start/end times, source IP address, session duration, and the like).

In some examples, the internal evidence collected at each checkpoint 220 includes software data about the apps 124 currently installed on the CVM 120. Software data can include, for example, what apps 124 are installed on the CVM 120 (e.g., application name, package name, version), software configuration data for each of the apps 124 (e.g., software and OS patch dependencies for the app 124, OS-level users for the app 124, internal users, and other configuration settings specific to the particular app 124), what network communications are enabled for this app 124 (e.g., active listening ports of the app 124 and its processes, firewall rules specific for the app 124), running process list for the app 124, or the like.

In some examples, the internal evidence collected at each checkpoint 220 includes network configuration settings of the CVM 120. Network configuration settings can include, for example, current methods of access enabled on the CVM 120 (e.g., secure shell (SSH) access, remote desktop access, serial port access), current firewall settings provided by the guest OS 126, network encryption settings, and a current list of listening ports and the associated parent processes.

In some examples, the internal evidence collected at each checkpoint 220 includes operating system data of the CVM 120 (e.g., of the guest OS 126). This OS data can include, for example, system settings of the OS 126 (e.g., services enabled, registry data), patches installed on the OS 126 (e.g., security updates and patches), storage settings (e.g., full disk encryption), auditing and logging settings (e.g., features configured to track and log system and user activities), kernel configuration settings (e.g., kernel signing, address space layout randomization (ASLR) to prevent kernel level attacks), and the like. In some examples, the internal evidence includes one or more hashes taken from aspects of the persistent storage used by the CVM 120 (e.g., of the root virtual disk or other vdisks assigned to the CVM 120, and their associated file system(s) or portions thereof). A hash of some portion of a filesystem can, for example, later be reproduced and compared against the original hash to ensure no changes have been made.

The SW policy 274 shown in FIG. 2 is referred to herein as a software policy, as it defines measurements collected from within the software of the CVM 120 (e.g., via the attestation agent 130, capturing data about aspects of the guest OS 126, the apps 124, or the like). The SW policy 274 may be similar to the policies 174 shown in FIG. 1 (e.g., where attestation requests 132 are sent to the attestation agent 130). SW policies 274 are distinguished from hardware (HW) policies (not separately shown), which define measurements collected from CC hardware 140 (e.g., where attestation requests 132 are sent to components of CC hardware 140). As such, the policies 174 shown in FIG. 1 can represent either or both HW policies and SW policies 274.

In the example, the data owner 202 reviews the build attestation report 240 prior to authorizing the use of the CVM 120C. For example, prior to trusting the CVM 120 with the protected data 128, the data owner 202 may review the build attestation report 240 to ensure that the final version of the CVM 120 meets certain standards of integrity. This may involve inspecting the evidence 230C captured after the final build state (e.g., at the final build checkpoint 220C) and comparing some or all of that evidence 230C against expected measurements. In some examples, this can be done via manual inspection of the build attestation report 240 and comparison to expected values by the data owner 202.

In the example, the data owner 202 configures an operational SW policy (not separately shown) that is used during runtime attestation operations (e.g., as shown in FIG. 1). The operational SW policy may be similar to the SW policy 274 used during the build process 200 shown in FIG. 2, as some or all of the measurements collected during the build process 200 or after the final build state checkpoint 220C may be the same measurements of interest to verify before the CVM 120 is trusted for operational use by the data owner 202. As such, the verification service 170 may allow the data owner 202 to create both an operational SW policy and an operational HW policy (e.g., as policies 174) for the CVM 120 and to control access to their protected data 128.

At operation 250, the data owner 202 verifies the build attestation report 240 and allows the attestation service 170 to use the CVM 120 to enter operational service using the final image of that CVM 120 (pending a successful runtime attestation). The operational phase of the CVM 120 is a phase in which the CVM 120 enters its primary production use, gaining access to the protected data 128 and executing the apps 124 using that protected data 128 under the CVM 120. This operational phase of the CVM 120 is restricted pending a successful runtime attestation of the CVM 120 and its associated CC hardware 140. In other words, the CVM 120 is not allowed to enter the operational phase (e.g., decrypting the protected data 128 and running the apps 124 with that protected data 128) unless it successfully performs attestation and verification with the attestation service 170.

Referring now to FIG. 1 and FIG. 2, the example CVM 120D is now in a final, running state (e.g., having an image of the final build state of CVM 120C running within the CVM 120 of FIG. 1). After the CVM 120 is booted within the CC system 110, the CVM 120 undergoes runtime attestation operations.

More specifically, in this example, the attestation service 170 performs a runtime attestation operation with the attestation agent 130 (e.g., a “software-based runtime attestation operation”). In some examples, the attestation service 170 may also perform a runtime attestation operation with one or more components of the CC hardware 140 (e.g., a “hardware-based runtime attestation operation”).

The measurements requested during the software-based runtime attestation operation are defined by the operational SW policy for the CVM 120, as defined by the data owner 202. This results in the attestation service 170 sending one or more attestation requests 132 to the attestation agent 130 of the CVM 120 and receiving evidence 134 from the attestation agent in response. This evidence 134 is compared to the operational SW policy of the CVM 120 to verify the integrity of the CVM 120. If any of the measurements do not match the expected values defined by the operational SW policy for that CVM 120, then the CVM 120 will not be allowed to enter operational service and will not be allowed to access the protected data 128 (e.g., via restricting access to the key 176 that can decrypt the protected data 128).

Similarly, if an operational HW policy is also configured for the CVM 120, the attestation service 170 may also send one or more attestation requests 132 to components of the CC hardware 140, receiving evidence 134 from the CC hardware 140 in response. This evidence is compared to the operational HW policy of the CVM 120 to verify the integrity of the CC hardware 140 that supports the CVM 120. Likewise, if any measurements do not match the expected values defined by the operational HW policy for that CVM 120, then the CVM 120 will not be allowed to enter operational service and will not be allowed to access the protected data 128 (e.g., via restricting access to the key 176 that can decrypt the protected data 128).

If the software-based runtime attestation operation is successfully verified by the attestation service 170 (and optionally if the hardware-based runtime attestation operation is also successfully verified), then the attestation service 170 sends the attestation decision 178 onto the key management service 180, and this key management service 180 releases the key 176 to the CVM 120 for use in decrypting the protected data 128. This “key gatekeeping” thus acts as a verification that the CVM 120 can continue into operational use, triggering the CVM 120 to decrypt the protected data 128 and begin operational execution of the apps 124 for their intended purpose.

In the example shown in FIG. 2, the CVM 120 is illustrated as being both the CVM used to build the golden image (e.g., during stages 1-3, shown as CVM 120A-120C), as well as the CVM 120D used during the operational phase of the CVM 120. However, this need not be the case. For example, the build process 200 may be performed on one CVM 120, either in the same or a similar architecture 100 as shown in FIG. 1, and this may result in the creation and storage of a golden image (e.g., an image of the storage of the final CVM 120C). This golden image may later be used to create an operational CVM 120D (e.g., a virtual machine different from the CVM 120A-120C used to create the golden image).

Further, in some examples, the data owner 202 may have administrative access to the CVM 120 during the build process 200, and may likewise have administrators that perform administrative operations on the CVM 120 during the build process 200. These build operations may similarly be captured by build state checkpoints 220 (e.g., either during contemporaneous access between the guest admin 204 and the data owner 202, or before or after the guest admin 204 has performed their operations).

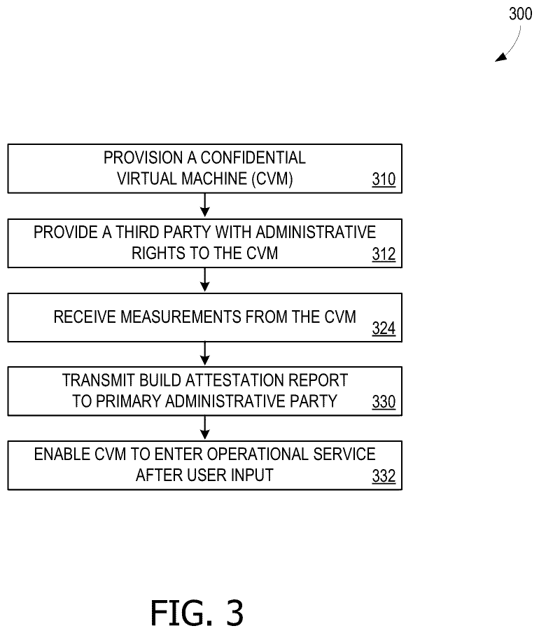

FIG. 3 is a flowchart 300 illustrating exemplary operations that may be performed by architecture 100 for providing software-based attestation during a build process of a CVM 120. In some examples, the operations of flowchart 300 may be similar to the operations shown in FIG. 2. In the example implementation, the operations of flowchart 300 are performed by the attestation service 170 in conjunction with the attestation agent 130 of FIG. 1.

At operation 310, the attestation service 170 provisions the CVM 120 (e.g., creates the CVM as a virtual machine entity within the confidential compute system 110). At operation 312, a third party (e.g., the guest admin 204 of FIG. 2) is provided with administrative rights to the CVM 120 (e.g., to perform software installation operations, make configuration changes, and the like). At operation 324, the attestation service 170 receives measurements (e.g., evidence 230) from the CVM 120, after a build process performed by the third party is complete. At operation 330, the attestation service 170 transmits the build attestation report 240 to a primary administrative party for the CVM 120 (e.g., the data owner 202), allowing the data owner 202 to review and certify or deny the build process for the CVM 120. The transmitted attestation report includes the one or more measurements. At operation 332, the attestation service 170 causes the CVM to enter operational service after input from a user such as the data owner 202 (e.g., upon successful certification of the attestation report, transmitting or otherwise allowing the transfer of an encryption key to the CVM 120 that allows the CVM 120 to decrypt the protected data 128 and commence use of the decrypted protected data 128 by the apps 124).

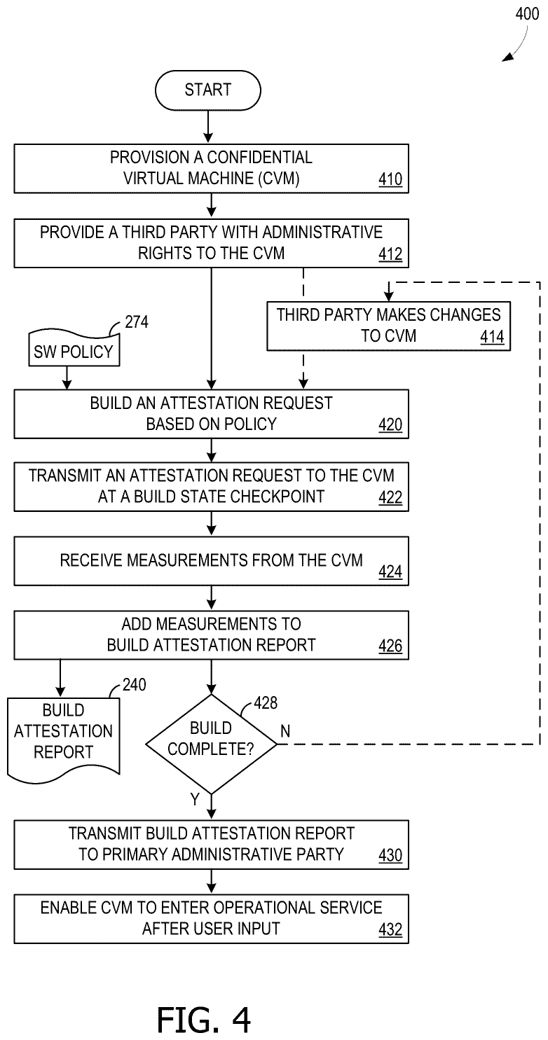

FIG. 4 is a flowchart 400 illustrating exemplary operations that may be performed by architecture 100 for providing software-based attestation during a build process of a CVM 120. In some examples, the operations of flowchart 400 may be similar to the operations shown in FIG. 2. In the example implementation, the operations of flowchart 400 are performed by the attestation service 170 in conjunction with the attestation agent 130 of FIG. 1.

At operation 410, the attestation service 170 provisions the CVM 120 (e.g., creates the CVM as a virtual machine entity within the confidential compute system 110). In some examples, this operation 410 includes installing an image of an operating system onto the CVM 120 (e.g., as guest OS 126) and may also include installing the attestation agent 130 onto the CVM 120. At operation 412, a third party (e.g., the guest admin 204 of FIG. 2) is provided with administrative rights to the CVM 120 (e.g., to perform software installation operations, make configuration changes, and the like). At operation 414, the third party performs a set of changes to the CVM 120.

After some changes are made to the CVM 120 by the third party, the attestation service 170 initiates a build checkpoint to collect measurements of the CVM 120 at that particular state or stage of the build process. More specifically, at operation 420, the attestation service 170 builds an attestation request (e.g., attestation request 132) based on the SW policy 274 configured for this CVM 120 (e.g., based on the measurements defined within the policy 274). At operation 422, the attestation service 170 transmits the attestation request to the CVM (e.g., to the attestation agent 130 executing on the CVM 120) at this build stage checkpoint. At operation 424, the attestation service 170 receives measurements (e.g., evidence 230) from the CVM 120 in response to the request. At operation 426, the attestation service 170 adds these measurements to the build attestation report 240, thus capturing and memorializing the measurements at this particular build stage checkpoint.

If, at test 428, the build of the CVM 120 is not yet complete (e.g., if the third party still has administrative rights), then the third party continues to make additional changes to the CVM 120 at operation 414, and another set of measurements may be taken at a later build stage checkpoint.

If, at test 428, the build of the CVM 120 is complete, then the attestation service 170 transmits the build attestation report 240 to a primary administrative party for the CVM 120 (e.g., the data owner 202) at operation 430, allowing the data owner 202 to review and certify or deny the build process for the CVM 120. At operation 432, the attestation service 170 causes the CVM to enter operational service after input from the data owner 202 (e.g., after successful certification).

In some examples, the attestation service 170 identifies an operational software policy that identifies the one or more measurements and expected values for the one or more measurements (e.g., as part of a runtime attestation operation) and transmits an attestation request to the attestation agent 130 being executed by the CVM, where the attestation request identifies the one or more measurements to be attested by the attestation agent. The attestation service 170 receives an evidence message from the attestation agent of the CVM, the evidence message including current readings for the one or more measurements captured from the CVM and verifies the current readings against for the one or more measurements using the expected values for the one or more measurements identified in the operational software policy, and where causing the CVM to enter operational service includes causing the CVM to enter operational service when the current readings are verified against the expected values.

In some examples, the attestation request is a software-based attestation request, and the method also includes transmitting a hardware-based attestation request to at least one component of the confidential computing hardware supporting the CVM prior to causing the CVM to enter operational service. In some examples, causing the CVM to enter operational service further includes transmitting an attestation decision to a key management service, thereby causing the key management service to transmit a decryption key to the CVM for use in decrypting protected data used during the operational service of the CVM. In some examples, the third-party modification of the CVM includes a software installation operation performed on the CVM by the third party, wherein the one or more measurements further includes information about software installed on the CVM. In some examples, the one or more measurements further includes information about administrative accounts currently present on the CVM. In some examples, the one or more measurements further includes a hash of a filesystem of the CVM.

### Additional Examples

An example confidential compute system comprises: at least one confidential compute component configured to support a confidential virtual machine (CVM): a processor; and a computer-readable medium storing instructions that are operative upon execution by the processor to: provision a confidential virtual machine (CVM) within the confidential compute system; provide a third party with administrative rights to the CVM, the administrative rights allow the third party to install software on the CVM; capture one or more measurements from the CVM after a build process performed by the third party is complete: transmit an attestation report to a primary administrative party of the CVM, the attestation report includes the one or more measurements; and cause the CVM to enter operational service with confidential data upon receiving user input from the primary administrative party after review of the attestation report.

An example method comprises: provisioning a confidential virtual machine (CVM) within a virtualization platform, the virtualization platform including confidential computing hardware configured to support encryption services to data while that data is in use on the CVM; providing a third party with administrative rights to the CVM, the administrative rights allowing the third party to modify a configuration of the CVM; after the administrative rights of the third party are removed from the CVM, receiving one or more measurements from the CVM; adding the one or more measurements to a build attestation report for the CVM; transmitting the attestation report to a primary administrative party of the CVM; and using the confidential computing hardware, causing the CVM to enter operational service with confidential data upon receiving certification user input from the primary administrative party after review of the attestation report.

One or more example computer storage devices have computer-executable instructions stored thereon, which, on execution by a computer, cause the computer to perform operations comprising: provisioning a confidential virtual machine (CVM) within a virtualization platform, the virtualization platform including confidential computing hardware configured to support encryption services to data while that data is in use on the CVM; providing a third party with administrative rights to the CVM, the administrative rights allowing the third party to modify a configuration of the CVM; after the administrative rights of the third party are removed from the CVM, capturing one or more measurements from the CVM; adding the one or more measurements to a build attestation report for the CVM; transmitting the attestation report to a primary administrative party of the CVM; and using the confidential computing hardware, causing the CVM to enter operational service with confidential data upon receiving certification user input from the primary administrative party after review of the attestation report.

Alternatively, or in addition to the other examples described herein, examples include any combination of the following:
provision a confidential virtual machine (CVM) within the confidential compute system;
provide a third party with administrative rights to the CVM, the administrative rights allow the third party to install software on the CVM;
capture one or more measurements from the CVM after a build process performed by the third party is complete;
transmit an attestation report to a primary administrative party of the CVM, the attestation report includes the one or more measurements;
cause the CVM to enter operational service with confidential data upon receiving user input from the primary administrative party after review of the attestation report;
identify an operational software policy that identifies the one or more measurements and expected values for the one or more measurements;
transmit an attestation request to an attestation agent being executed by the CVM, the attestation request identifies the one or more measurements to be attested by the attestation agent: receive an evidence message from the attestation agent of the CVM, the evidence message including current readings for the one or more measurements captured from the CVM;
verify the current readings against for the one or more measurements using the expected values for the one or more measurements identified in the operational software policy;
causing the CVM to enter operational service includes causing the CVM to enter operational service when the current readings are verified against the expected values;
the attestation request is a software-based attestation request;
transmit a hardware-based attestation request to at least one component of the confidential computing hardware supporting the CVM prior to causing the CVM to enter operational service;
causing the CVM to enter operational service further includes transmitting an attestation decision to a key management service, thereby causing the key management service to transmit a decryption key to the CVM for use in decrypting protected data used during the operational service of the CVM;
third party modification of the CVM includes a software installation operation performed on the CVM by the third party;
measurements include information about software installed on the CVM;
measurements include information about administrative accounts currently present on the CVM;
measurements include a hash of a filesystem of the CVM;
provisioning a confidential virtual machine (CVM) within a virtualization platform;
a virtualization platform includes confidential computing hardware configured to support encryption services to data while that data is in use on the CVM;
providing a third party with administrative rights to the CVM;
administrative rights allow a third party to modify a configuration of the CVM;
after the administrative rights of the third party are removed from the CVM, receiving one or more measurements from the CVM;
adding the one or more measurements to a build attestation report for the CVM;
transmitting the attestation report to a primary administrative party of the CVM;
causing the CVM to enter operational service with confidential data upon receiving certification user input from the primary administrative party after review of the attestation report;
identifying an operational software policy that identifies the one or more measurements and expected values for the one or more measurements;
transmitting an attestation request to an attestation agent being executed by the CVM;
an attestation request identifies the one or more measurements to be attested by the attestation agent;
receiving an evidence message from the attestation agent of the CVM;
an evidence message includes current readings for the one or more measurements captured from the CVM;
verifying the current readings against for the one or more measurements using the expected values for the one or more measurements identified in the operational software policy
causing the CVM to enter operational service when the current readings are verified against the expected values;
providing a hardware-based attestation verification of at least one component of the confidential computing hardware supporting the CVM prior to causing the CVM to enter operational service;
transmitting an attestation decision to a key management service, thereby causing the key management service to transmit a decryption key to the CVM for use in decrypting protected data used during the operational service of the CVM;
third party modification of the CVM includes a software installation operation performed on the CVM by the third party;
measurements include information about software installed on the CVM;
measurements include information about administrative accounts currently present on the CVM;
measurements further includes a hash of a filesystem of the CVM;
a key management service manages decryption keys;
providing a decryption key in response to a successful attestation and verification;
receiving user input initiating a build state checkpoint and capturing of measurements during a build process;
writing a change log to a build attestation report;
a change log documents what changes were made to a CVM;
auditing a golden image of a CVM by recreating changes and comparing new measurements to past measurements made during the build of the CVM;
an attestation service that provides both hardware-based and software-based attestations and verifications;
at attestation agent is installed on a CVM;
an attestation agent executes on a CVM;
an attestation agent captures configuration information of a CVM while executing on the CVM; and
providing a user interface to a data owner for viewing a build attestation report and receiving user input verifying use of a golden image for the CVM during an operational phase.

While the aspects of the disclosure have been described in terms of various examples with their associated operations, a person skilled in the art would appreciate that a combination of operations from any number of different examples is also within scope of the aspects of the disclosure.

### Example Operating Environment

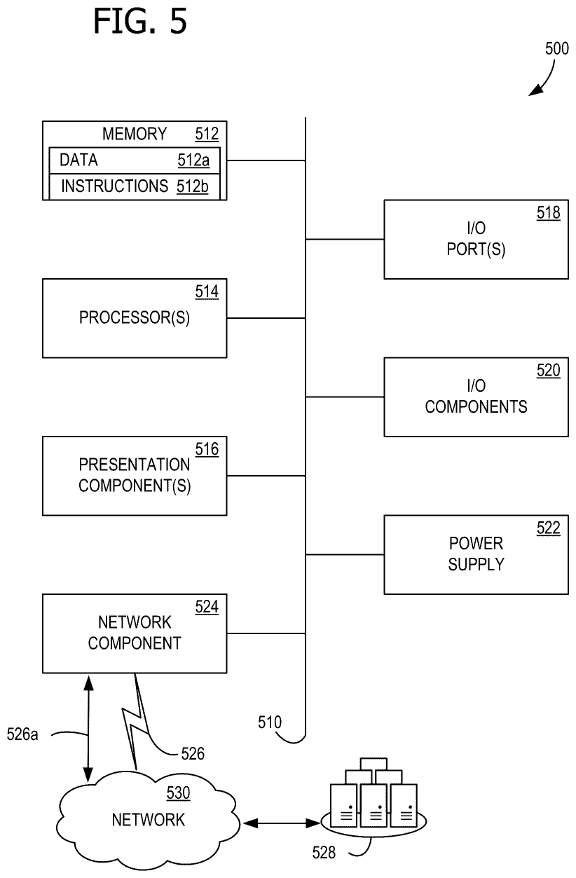

FIG. 5 is a block diagram of an example computing device 500 (e.g., a computer storage device) for implementing aspects disclosed herein, and is designated generally as computing device 500. In some examples, one or more computing devices 500 are provided for an on-premises computing solution. In some examples, one or more computing devices 500 are provided as a cloud computing solution. In some examples, a combination of on-premises and cloud computing solutions are used. Computing device 500 is but one example of a suitable computing environment that can be used in architecture 100 and is not intended to suggest any limitation as to the scope of use or functionality of the examples disclosed herein, whether used singly or as part of a larger set. Neither should computing device 500 be interpreted as having any dependency or requirement relating to any one or combination of components/modules illustrated.

The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 500 includes a bus 510 that directly or indirectly couples the following devices: computer storage memory 512, one or more processors 514, one or more presentation components 516, input/output (I/O) ports 518, I/O components 520, a power supply 522, and a network component 524. While computing device 500 is depicted as a seemingly single device, multiple computing devices 500 may work together and share the depicted device resources. For example, memory 512 may be distributed across multiple devices, and processor(s) 514 may be housed with different devices.

Bus 510 represents what may be one or more busses (such as an address bus, data bus, or a combination thereof). Although the various blocks of FIG. 5 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 5 and the references herein to a “computing device.” Memory 512 may take the form of the computer storage media referenced below and operatively provide storage of computer-readable instructions, data structures, program modules and other data for the computing device 500. In some examples, memory 512 stores one or more of an operating system, a universal application platform, or other program modules and program data. Memory 512 is thus able to store and access data 512a and instructions 512b that are executable by processor 514 and configured to carry out the various operations disclosed herein.

In some examples, memory 512 includes computer storage media. Memory 512 may include any quantity of memory associated with or accessible by the computing device 500. Memory 512 may be internal to the computing device 500 (as shown in FIG. 5), external to the computing device 500 (not shown), or both (not shown). Additionally, or alternatively, the memory 512 may be distributed across multiple computing devices 500, for example, in a virtualized environment in which instruction processing is carried out on multiple computing devices 500. For the purposes of this disclosure, “computer storage media,” “computer-storage memory,” “memory,” and “memory devices” are synonymous terms for the computer-storage memory 512, and none of these terms include carrier waves or propagating signaling.

Processor(s) 514 may include any quantity of processing units that read data from various entities, such as memory 512 or I/O components 520. Specifically, processor(s) 514 are programmed to execute computer-executable instructions for implementing aspects of the disclosure. The instructions may be performed by the processor, by multiple processors within the computing device 500, or by a processor external to the client computing device 500. In some examples, the processor(s) 514 are programmed to execute instructions such as those illustrated in the flow charts discussed below and depicted in the accompanying drawings. Moreover, in some examples, the processor(s) 514 represent an implementation of analog techniques to perform the operations described herein. For example, the operations may be performed by an analog client computing device 500 and/or a digital client computing device 500. Presentation component(s) 516 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 500, across a wired connection, or in other ways. I/O ports 518 allow computing device 500 to be logically coupled to other devices including I/O components 520, some of which may be built in. Example I/O components 520 include, for example but without limitation, a microphone, joystick, game pad, satellite dish, scanner, printer, wireless device, etc.

Computing device 500 may operate in a networked environment via the network component 524 using logical connections to one or more remote computers. In some examples, the network component 524 includes a network interface card and/or computer-executable instructions (e.g., a driver) for operating the network interface card. Communication between the computing device 500 and other devices may occur using any protocol or mechanism over any wired or wireless connection. In some examples, network component 524 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 524 communicates over wireless communication link 526 and/or a wired communication link 526a to a remote resource 528 (e.g., a cloud resource) across network 530. Various different examples of communication links 526 and 526a include a wireless connection, a wired connection, and/or a dedicated link, and in some examples, at least a portion is routed through the internet.

Although described in connection with an example computing device 500, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure do not include signals. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A confidential compute system comprising:
at least one confidential compute component configured to support a confidential virtual machine (CVM);
a processor; and
a computer-readable medium storing instructions that are operative upon execution by the processor to:
provision a confidential virtual machine (CVM) within the confidential compute system;
provide a third party with administrative rights to the CVM, the administrative rights allowing the third party to install software on the CVM;
capture one or more measurements from the CVM after a build process performed by the third party is complete;
transmit an attestation report to a primary administrative party of the CVM, the attestation report including the one or more measurements; and
cause the CVM to enter operational service with confidential data upon receiving user input from the primary administrative party after review of the attestation report.

2. The confidential compute system of claim 1, wherein the instructions are further operative to:
identify an operational software policy that identifies the one or more measurements and expected values for the one or more measurements;
transmit an attestation request to an attestation agent being executed by the CVM, the attestation request identifies the one or more measurements to be attested by the attestation agent;
receive an evidence message from the attestation agent of the CVM, the evidence message including current readings for the one or more measurements captured from the CVM; and
verify the current readings against for the one or more measurements using the expected values for the one or more measurements identified in the operational software policy,
wherein causing the CVM to enter operational service includes causing the CVM to enter operational service when the current readings are verified against the expected values.

3. The confidential compute system of claim 2, wherein the attestation request is a software-based attestation request, wherein the instructions are further operative to transmit a hardware-based attestation request to the at least one confidential compute component supporting the CVM prior to causing the CVM to enter operational service.

4. The confidential compute system of claim 1, wherein causing the CVM to enter operational service further includes transmitting an attestation decision to a key management service, thereby causing the key management service to transmit a decryption key to the CVM for use in decrypting protected data used during the operational service of the CVM.

5. The confidential compute system of claim 1, wherein third-party modification of the CVM includes a software installation operation performed on the CVM by the third party, wherein the one or more measurements further includes information about software installed on the CVM.

6. The confidential compute system of claim 1, wherein the one or more measurements further includes information about administrative accounts currently present on the CVM.

7. The confidential compute system of claim 1, wherein the one or more measurements further includes a hash of a filesystem of the CVM.

8. A computer-implemented method comprising:
provisioning a confidential virtual machine (CVM) within a virtualization platform, the virtualization platform including confidential computing hardware configured to support encryption services to data while that data is in use on the CVM;
providing a third party with administrative rights to the CVM, the administrative rights allowing the third party to modify a configuration of the CVM;
after the administrative rights of the third party are removed from the CVM, receiving one or more measurements from the CVM;
adding the one or more measurements to a build attestation report for the CVM;
transmitting the build attestation report to a primary administrative party of the CVM; and
using the confidential computing hardware, causing the CVM to enter operational service with confidential data upon receiving certification user input from the primary administrative party after review of the attestation report.

9. The method of claim 8, further comprising:
identifying an operational software policy that identifies the one or more measurements and expected values for the one or more measurements;
transmitting an attestation request to an attestation agent being executed by the CVM, the attestation request identifies the one or more measurements to be attested by the attestation agent;
receiving an evidence message from the attestation agent of the CVM, the evidence message including current readings for the one or more measurements captured from the CVM; and
verifying the current readings against for the one or more measurements using the expected values for the one or more measurements identified in the operational software policy,
wherein causing the CVM to enter operational service includes causing the CVM to enter operational service when the current readings are verified against the expected values.

10. The method of claim 9, further comprising providing a hardware-based attestation verification of at least one component of the confidential computing hardware supporting the CVM prior to causing the CVM to enter operational service.

11. The method of claim 8, wherein causing the CVM to enter operational service further includes transmitting an attestation decision to a key management service, thereby causing the key management service to transmit a decryption key to the CVM for use in decrypting protected data used during the operational service of the CVM.

12. The method of claim 8, wherein third party modification of the CVM includes a software installation operation performed on the CVM by the third party, wherein the one or more measurements further includes information about software installed on the CVM.

13. The method of claim 8, wherein the one or more measurements further includes information about administrative accounts currently present on the CVM.

14. The method of claim 8, wherein the one or more measurements further includes a hash of a filesystem of the CVM.

15. A computer storage device having computer-executable instructions stored thereon, which, on execution by a computer, cause the computer to perform operations comprising:
provisioning a confidential virtual machine (CVM) within a virtualization platform, the virtualization platform including confidential computing hardware configured to support encryption services to data while that data is in use on the CVM;
providing a third party with administrative rights to the CVM, the administrative rights allowing the third party to modify a configuration of the CVM;
after the administrative rights of the third party are removed from the CVM, capturing one or more measurements from the CVM;
adding the one or more measurements to a build attestation report for the CVM;
transmitting the build attestation report to a primary administrative party of the CVM; and
using the confidential computing hardware, causing the CVM to enter operational service with confidential data upon receiving certification user input from the primary administrative party after review of the attestation report.

16. The computer storage device of claim 15, further comprising:
identifying an operational software policy that identifies the one or more measurements and expected values for the one or more measurements;
transmitting an attestation request to an attestation agent being executed by the CVM, the attestation request identifies the one or more measurements to be attested by the attestation agent;
receiving an evidence message from the attestation agent of the CVM, the evidence message including current readings for the one or more measurements captured from the CVM; and
verifying the current readings against for the one or more measurements using the expected values for the one or more measurements identified in the operational software policy,
wherein causing the CVM to enter operational service includes causing the CVM to enter operational service when the current readings are verified against the expected values.

17. The computer storage device of claim 16, further comprising providing a hardware-based attestation verification of at least one component of the confidential computing hardware supporting the CVM prior to causing the CVM to enter operational service.

18. The computer storage device of claim 15, wherein causing the CVM to enter operational service further includes transmitting an attestation decision to a key management service, thereby causing the key management service to transmit a decryption key to the CVM for use in decrypting protected data used during the operational service of the CVM.

19. The computer storage device of claim 15, wherein third party modification of the CVM includes a software installation operation performed on the CVM by the third party, wherein the one or more measurements further includes information about software installed on the CVM.

20. The computer storage device of claim 15, wherein the one or more measurements further includes information about administrative accounts currently present on the CVM.
